(19) United States
(12) Patent Application Publication
(10) Pub. No.: US 2024/0408519 A1
(43) Pub. Date: Dec. 12, 2024

(54) DISC FILTER CONTROL SYSTEMS AND METHODS

(71) Applicant: Kadant Black Clawson LLC, Lebanon, OH (US)

(72) Inventors: Hugues Dionne, Le Gardeur (CA); Daniel Parenteau, Montreal (CA)

(73) Assignee: Kadant Black Clawson LLC, Lebanon, OH (US)

(21) Appl. No.: 18/734,753

(22) Filed: Jun. 5, 2024

Related U.S. Application Data
(60) Provisional application No. 63/472,051, filed on Jun. 9, 2023.

(51) Int. Cl. B01D 33/21; B01D 33/80

(52) U.S. Cl. CPC B01D 33/21; B01D 33/801; B01D 33/804

(57) ABSTRACT

A disc filter system and method for dewatering a fiber suspension is disclosed. The disc filter system includes a disc filter and a control system. The disc filter comprises an inlet for introducing the fiber suspension into the vessel, a rotor shaft and a variable speed drive operatively coupled to the rotor shaft, and at least one filter element coupled to the rotor shaft wherein the at least one filter element rotates with the rotor shaft. The control system measures a torque on the variable speed drive and causes the variable speed drive to adjust the rotational speed of the rotor shaft from a first rotational speed to a second rotational speed based on the torque on the variable speed drive.

### CROSS-REFERENCE TO RELATED APPLICATIONS

This application claims the benefit of U.S. Provisional Patent Application Ser. No. 63/472,051, entitled “Disc Filter Control Systems and Methods,” filed Jun. 9, 2023, the contents of which are incorporated herein by reference.

### TECHNICAL FIELD

The present specification generally relates to systems and methods for concentrating a fiber suspension and, more specifically, to disc filter control systems and methods for dewatering fiber suspensions, such as fiber suspensions in the pulp and paper industry.

### BACKGROUND

Typical disc filters used in the pulp and paper industry for dewatering cellulose fiber suspensions generally include a number of disc-shaped filter elements mounted on a rotatable shaft such that the filter elements rotate together with the rotor shaft inside a vessel. The disc-shaped filter elements are partly immersed in a cellulose fiber suspension contained within the vessel. Each filter element may include several filter sectors distributed about the rotatable shaft. Each filter sector is provided with an external filter lining, such as a screen or the like, and internal flow channels communicating with filtrate channels in the rotatable shaft.

When the filter elements are rotated with the rotatable shaft, the filter sectors move through the suspension in the vessel. As the filter sectors move through the suspension, water is sucked from the suspension, through the filtering lining on the filter sectors and into the flow channels inside the filter sectors, while fiber material is deposited as a fiber mat on the external surfaces of the filtering lining. The filtrate comprising said water then flows from the flow channels in the filter sectors to the filtrate channels in the rotor shaft and is discharged from the vessel through a filtrate outlet. On continued rotation of the filter elements, the filter sectors move out of the suspension and past spray nozzles, which direct jets of fluid towards the fiber mat to thereby loosen the fiber mat from the filtering lining. The fiber material loosened from the filtering lining falls down into receiver chutes located alongside of the filtering lining on each side of the respective filter element in the part of the vessel where the filter sectors are rotated out of the suspension after having moved through the suspension, i.e., on the side of the rotor shaft where the filter sectors move upwards during the rotation of the filter elements. At the bottom of the receiver chutes the fiber material is picked up by a conveyor and passed on for further processing.

### SUMMARY

In certain operating conditions, the fiber suspension in the vessel of the disc filter can thicken to a significant extent, thereby increasing the risk that the filter elements of the disc filter, also referred to herein as “discs,” will crash due to high lateral forces generated by the thickened fiber suspension. An ongoing need exists for improved control systems and methods for controlling disc filters that appropriately respond to operating conditions that lead to substantial thickening of the fiber suspension in the vessel in order to prevent damage to the discs and improve operation of the disc filter. The disc filter control systems disclosed herein may be operable to receive signals from one or more measuring devices corresponding to variables of the disc filter system and adjust one or more control devices based on signals received from the measuring devices. The torque on the drive used to rotate the rotor shaft may be used to determine the extent of the lateral forces acting on the filter elements rotating in the fiber suspension, and thus used to determine the risk of failure of the filter elements. The present disclosure describes control systems and methods wherein the operating parameters of the disc filter, such as but not limited to the rotational speed, vacuum pressure, and/or liquid level, are controlled at least in part based on the torque on the drive used to rotate the rotor shaft of the disc filter.

The present disclosure provides a disc filter system for dewatering fiber suspensions. The disc filter system comprises a disc filter and a control system. The disc filter comprises a vessel having an inlet positioned in a wall of the vessel, the inlet introducing a fiber suspension into the vessel. The disc filter further comprises a rotor shaft comprising a shaft axis of rotation and a variable speed drive operatively coupled to the rotor shaft and configured to rotate the rotor shaft about the shaft axis of rotation. The disc filter further comprises at least one filter element, which may be a disc-shaped filter element, coupled to the rotor shaft wherein the at least one filter element rotates with the rotor shaft about the shaft axis of rotation. The control system comprises at least one processor, at least one memory module communicatively coupled to the processor, and machine readable and executable instructions stored on the memory module. The control system may be communicatively coupled to the variable speed drive and a torque measurement device operable to measure a torque on the variable speed drive. The machine readable and executable instructions, when executed by the processor, may cause the disc filter system to automatically: measure the torque on the variable speed drive; and adjust a rotational speed of the rotor shaft from a first rotational speed to a second rotational speed that is non-zero and different from the first rotational speed based on the torque on the variable speed drive. The rotational speed of the rotor shaft may be adjusted using the variable speed drive.

The present disclosure also provides a method for dewatering fiber suspensions. The method may comprise introducing a fiber suspension to a disc filter comprising: a vessel comprising an inlet positioned in a wall of the vessel, the inlet introducing a fiber suspension into the vessel; a rotor shaft comprising a shaft axis of rotation; at least one filter element coupled to the rotor shaft wherein the at least one filter element rotates with the rotor shaft about the shaft axis of rotation. The method may further include rotating the rotor shaft about the shaft axis of rotation; measuring a torque on a drive used to rotate the rotor shaft about the shaft axis of rotation; and adjusting a rotational speed of the rotor shaft from a first rotational speed to a second rotational speed that is non-zero and different from the first rotational speed based on the torque on the variable speed drive.

Additional features and advantages of the disc filters described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an axial cross section of a disc filter system, according to one or more embodiments shown and described herein;

FIG. 2 is a cross section of the disc filter system of FIG. 1 along the line A-A, according to one or more embodiments shown and described herein;

FIG. 3 schematically depicts a disc filter system, according to one or more embodiments shown and described herein.

For the purposes of describing the simplified schematic illustrations and descriptions of the drawings, the numerous valves, temperature sensors, flow meters, pressure regulators, electronic controllers, pumps, and the like that may be employed and well known to those of ordinary skill in the art of certain processing operations may not be included. Further, accompanying components that are often included in typical processing operations, such as valves, pipes, pumps, agitators, instrumentation, internal vessel structures, or other subsystems, may not be depicted. Though not depicted, it should be understood that these components are within the spirit and scope of the present embodiments disclosed. However, operational components, such as those described in the present disclosure, may be added to the embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

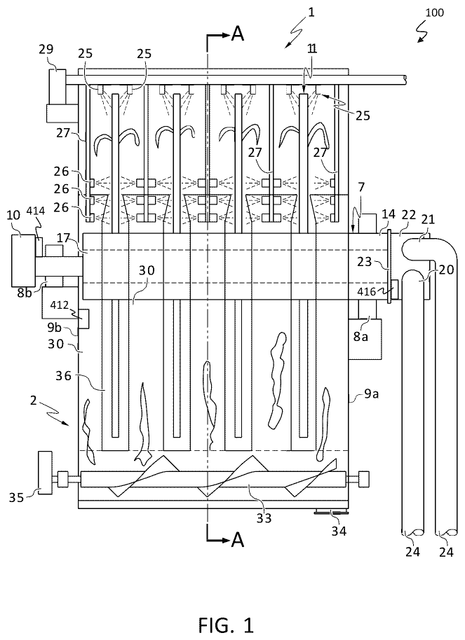

Reference will now be made in detail to embodiments of the disc filter systems described herein, examples of which are illustrated in the accompanying drawings. Whenever possible, the same reference numerals will be used throughout the drawings to refer to the same or like parts. One embodiment of a disc filter system 100 is schematically depicted in FIG. 1 and generally includes a disc filter 1 and a control system 400. The disc filter 1 includes a vessel 2 comprising an inlet 3 positioned in a wall of the vessel 2, the inlet 3 introducing a fiber suspension into the vessel 2. The disc filter 1 further includes a rotor shaft 7 comprising a shaft axis of rotation 131. A drive 10, e.g., a variable speed drive, is used to rotate the rotor shaft 7 about the shaft axis of rotation 131. At least one filter element 11 may be coupled to the rotor shaft 7 such that the at least one filter element 11 rotates with the rotor shaft 7 about the shaft axis of rotation 131. The control system 400 is communicatively coupled to the drive 10 and a torque measurement device 414 operable to measure a torque on the drive 10. The control system 400 may be configured to adjust the rotational speed of the rotor shaft 7 from a first rotational speed to a second rotational speed based on the torque on the drive 10. The various embodiments of disc filter systems and methods for operating the same will be described herein with specific reference to the appended drawings.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the terms “upstream” and “downstream” refer to the positioning of components or units of the systems relative to a direction of flow of materials through the systems. For example, a first component may be considered “upstream” of a second component if materials passing through the system encounter the first component before encountering the second component. The first component may be considered “downstream” of the second component if the materials encounter the second component before encountering the first component.

As used herein, the term “consistency” refers to the concentration of solid fibers in a fiber suspension and is equal to the weight of solid fibers in a sample volume divided by the total weight of the fiber suspension in the sample volume.

As used herein, the term “vacuum pressure” refers to an absolute pressure reading, where the pressure is less than atmospheric pressure. According to this definition, the vacuum pressure is inversely proportional to the degree of vacuum on the disc filter so that when the vacuum pressure decreases (i.e., difference between the vacuum pressure and atmospheric pressure increases), the amount of vacuum on the disc filter increases. Conversely, when the vacuum pressure increases (i.e., the difference between the vacuum pressure and atmospheric pressure decreases) the amount of vacuum on the disc filter decreases.

Disc filters are used to separate cellulose fiber from a suspension of the cellulose fibers in a fluid, such as water. Examples of disc filters are disclosed in: U.S. Pat. No. 9,238,188 entitled “Disc Filter” and assigned to Kadant Black Clawson Inc.; U.S. Pat. No. 4,136,028 entitled “Method for filtering a fibrous material by means of a disc filter as well as a disc filter for performing the method” and assigned to Rauma-Rapola Oy; and U.S. Pat. No. 6,258,282 entitled “Rotatable filter system for filtration of a flowing substance” and assigned to Kvaerner Pulping AB. In certain operating conditions, the fiber suspension can thicken to a significant extent in the vessel of the disc filter thereby causing the filter elements to crash (e.g., contact one another) due to the high lateral forces generated by the thickened fiber suspension in the vessel. Crashing of the filter elements may cause damage to the filter elements. The systems and methods of the present disclosure may reduce or prevent high-density material from building up in the vessel and, thereby, may reduce or prevent damage to the filter elements caused by crashing. The systems and methods of the present disclosure may also improve the operating efficiency of the disc filter under all process and machine conditions.

In typical disc filter operations, a drive is used to rotate the rotor shaft, which has filter elements mounted thereon. The filter elements are rotated in and out of the fiber suspension of the disc filter. As the filter elements are rotated, the filter elements are acted upon by varying levels of lateral forces and shear stresses based in part on the consistency of the fiber suspension. As the consistency of the fiber suspension increases, the density and/or the viscosity of the fiber suspension may increase thereby causing the filter elements to experience greater lateral forces. As the extent of these lateral forces increases, the risk of disc failure increases as well. Measuring the torque on the drive used to rotate the rotor shaft may be used to determine the extent of these lateral forces. Currently existing disc filter control methods involve monitoring the torque on the drive of the disc filter and, in response to the torque reaching a predetermined high threshold torque, switching off the drive and stopping the rotor to avoid damage to the filter elements. As such, in order to protect the filter elements from crashing upon an indication of increased consistency of the fiber suspension, the current control methods employ reducing and ultimately stopping the rotational speed of the rotor shaft (e.g., reducing the rotational speed to zero).

The Inventors of the present subject matter have discovered that the performance of disc filter systems can be improved by controlling the rotational speed of the rotor shaft in response to the torque measured on the drive used to rotate the rotor shaft. When the rotational speed of the filter elements is increased, the fiber material removal rate is increased relative to the filtrate removal rate, and the consistency of the fiber suspension decreases. When the rotational speed of the filter elements is decreased, the fiber material removal rate is decreased relative to the filtrate removal rate, and the consistency of the fiber suspension increases.

The disc filter systems and methods of the present disclosure measure the torque on the drive used to rotate the rotor shaft and adjust the rotational speed of the rotor shaft based on the measured torque. In particular, the disc filter systems and methods of the present disclosure measure the torque on the drive used to rotate rotor shaft, and when the measured torque exceeds a threshold value, the rotational speed of the rotor shaft may be increased, which in turn reduces the density and/or viscosity of the fiber suspension. Reducing the density and/or viscosity of the fiber suspension can reduce the lateral forces exerted on the filter elements, thereby reducing the risk of disc failure. The disc filter systems and methods disclosed herein further include additional control methods that further reduce the risk of disc failure and improve the operational efficiency of the disc filter. For example, when the rotational speed of the filter elements is increased, e.g., via an increase in the rotational speed of the rotor shaft, the fill level of the fiber suspension in the disc filter system may decrease as a result of increased fiber material removal rate and filtrate removal rate. In returning the fill level to the desired level in the vessel, it has been found that diluting the fiber suspension fed to the vessel may complement the increased rotational speed of the filter elements to further reduce the consistency of the fiber suspension in the vessel and thereby further reduce the risk of disc failure.

In embodiments, the disc filter control system may maintain the torque on the drive at a torque setpoint by controlling the rotational speed of the rotor shaft. In embodiments, the disc filter control system may implement a proportional-integral-derivative (PID) control scheme to maintain the torque on the drive at the torque setpoint by controlling the rotational speed of the rotor shaft. Similarly, in embodiments, the disc filter control system may implement a PID control scheme to maintain the fill level in the vessel at a setpoint level by controlling the flow rate of fiber suspension into the vessel and/or controlling the flow rate of dilution liquid into the fiber suspension prior to the fiber suspension being introduced into the vessel.

In embodiments, the disc filter control systems and methods may include determining if, even after increasing the speed of the rotor shaft for a certain period of time, the vacuum pressure on the filter elements is above a high threshold vacuum pressure, and if so, shutting down the disc filter to prevent disc failure.

Disclosed herein are embodiments of disc filter systems wherein the rotational speed of the disc filter is adjusted as a function of the torque on the drive used to rotate the disc filter. The disc filter systems of the present disclosure include a disc filter as well as a control system for controlling the operation of the disc filter.

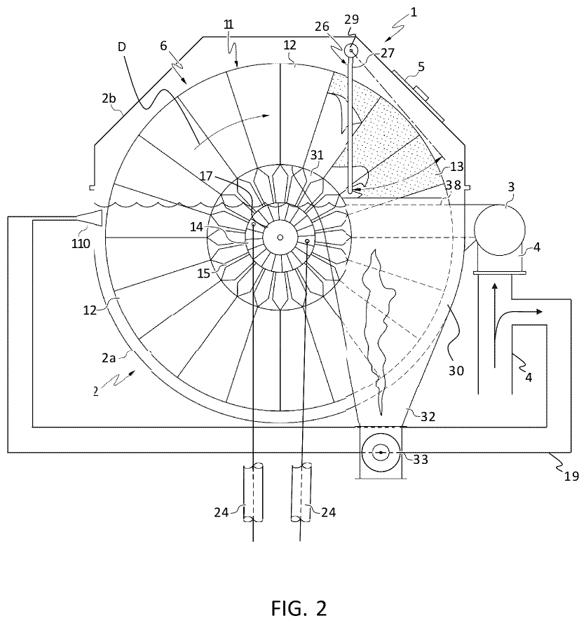

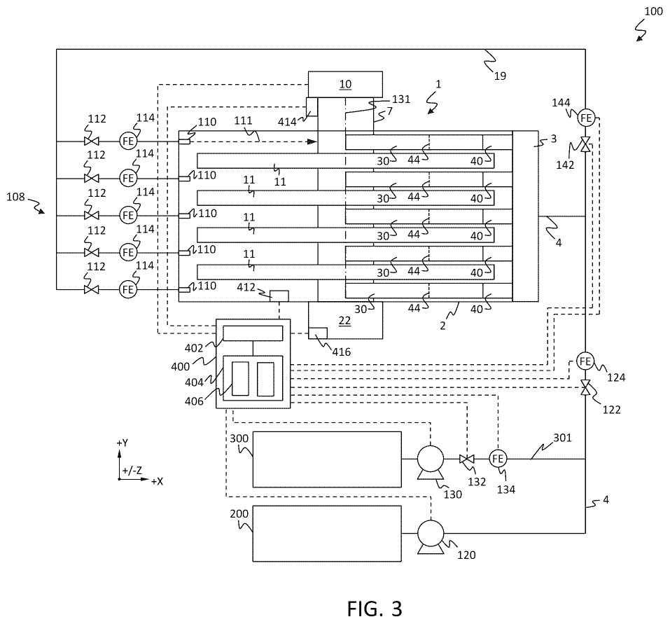

Referring now to FIGS. 1 and 3, the disc filter system 100 may comprise a disc filter 1 and a control system 400 communicatively coupled to the disc filter 1. Referring to FIGS. 1 and 2, the disc filter 1 may comprise a vessel 2 having an inlet 3 for introducing a fiber suspension, such as but not limited to a cellulose fiber suspension, into the vessel 2. The inlet 3 is connected to a conduit 4, through which the fiber suspension is supplied to the inlet 3 (such as by a primary pump 120 as shown in FIG. 3). The vessel 2 may comprise a lower part 2a and an upper part 2b connected to the lower part 2a. The lower part 2a may have a generally u-shaped configuration and may be closed at the top by the upper part 2b, which may form a hood over the lower part. The upper part 2a of the vessel 2 and the lower part 2b of the vessel 2 together generally define an inner space of the vessel.

In embodiments, the inlet 3 of the vessel 2 may comprise a plurality of inlet openings (not shown in FIGS. 1 and 2) located in the part of the vessel 2 where the filter elements 11, during the rotation of the rotor unit 6, are rotated down into the fiber suspension in the vessel from a position above the fiber suspension. The plurality of inlet openings may be configured to introduce the fiber suspension into the spaces 36 between the receiver chutes 30. The inlet 3 and its inlet openings may be configured to introduce the fiber suspension flow into the vessel 2 in a direction conforming to the rotational direction of the filter elements 11.

As shown in FIG. 2, the inner space of the vessel 2 may be accessible through a hatch 5 in the upper part 2b of the vessel. As shown in FIG. 1, a fill level sensor 412 may be coupled to the vessel 2 and operable to measure a fill level of the fiber suspension in the vessel 2. In embodiments, the fill level sensor 412 may be, as non-limiting examples, a radar sensor, a capacitance sensor, a tuning fork sensor, a diaphragm sensor, and float level sensor, an ultrasonic sensor, an infrared sensor, a nuclear sensor, or combinations thereof. The control system 400 may be communicatively coupled with the fill level sensor 412 and configured to receive a fill level signal from the fill level sensor 412.

The disc filter further comprises a rotor unit 6 located in the inner space of the vessel 2. The rotor unit 6 comprises a rotor shaft 7, which may be rotatably mounted to the vessel 2 and may extend across the inner space of the vessel. In embodiments, the rotor shaft 7 may be rotatably mounted to the lower part 2a of the vessel through a first bearing 8a arranged at a first end of the rotor shaft and a second bearing 8b arranged at the other end of the rotor shaft 7. The rotor shaft 7 may extend through sealed openings in gable wall 9a and gable wall 9b of the vessel 2 and may be rotated by means of a drive 10, for instance in the form of a drive motor, which may be operatively coupled to the rotor shaft 7. It should be understood that while the direction of rotation D of the rotor shaft 7 in the embodiment shown in FIG. 2 is clockwise, in embodiments, the direction of rotation of the rotor shaft may be counter-clockwise. The drive 10 may be an electric motor, hydraulic motor, or other type of drive capable of rotating the rotor shaft 7. In embodiments, the drive 10 may rotate the rotor shaft 7 as well as control the rotational speed of the rotor shaft 7. In embodiments, the drive 10 may be a variable speed drive (VSD) including both a device for rotating the rotor shaft 7, such as an electric motor or a hydraulic motor, and a device for controlling the power to the device used to rotate the rotor shaft 7, such as a variable frequency controller implementing pulsed-wave modulation or a mechanical linkage, such as but limited to a variable speed transmission or other device. A torque measurement device 414 may be coupled to the drive 10 and operable to measure a torque on the drive 10. The control system 400 may be communicatively coupled with the torque measurement device 414 and configured to receive a torque signal from the torque measurement device 414.

In embodiments, the drive 10 may be an electric drive, and the torque measurement device 414 may include an ammeter operable to measure the electrical current load on the drive 10 in combination with a rotor shaft speed sensor for measuring the rotational speed of the rotor shaft 7. If the efficiency of the drive 10 is known, the speed and amperage can be combined to determine the torque on the drive 10. In embodiments, the torque on the drive 10 may also be measured directly using, for example, a rotational torque sensor and strain gauge. Any other torque sensor or measurement device currently available or developed in the future may also be suitable for the torque measurement device 414 and are contemplated in the present disclosure.

As the consistency of the fiber suspension in the vessel 2 increases, the torque on the filter elements 11 of the rotor unit 6 may increase due to increased density and/or viscosity of the fiber suspension. The increase in torque results in greater current demand from the drive 10 to maintain rotation of the rotor unit 6 at a given rotational speed. Thus, measuring the rotational speed and the current drawn by the drive 10 may be indicative of the torque on the rotor unit 6, which can be correlated to the consistency of the fiber suspension in the vessel 2. In embodiments, the drive 10 may also be a hydraulic motor and the torque measurement device 414 may be a device operable to measure one or more operation conditions, such as but not limited to hydraulic pressure, speed, etc., of the hydraulic motor to determine the torque.

The control system 400 may be communicatively coupled to the drive 10 and configured to adjust a rotational speed of the rotor shaft 7. In embodiments in which the drive 10 is a VSD, the control system 400 may be configured to send a speed control signal to the VSD that is used by the VSD to control the power sent to the device of the VSD used to rotate the rotor shaft 7. As discussed in more detail herein, the control system 400 may control the rotational speed of the rotor shaft 7 based on one or more signals received from one or more sensors of the disc filter system 100.

Referring again to FIGS. 1 and 2, the rotor unit 6 also comprises at least one filter element 11 carried by the rotor shaft 7 in order to rotate together with the rotor shaft 7 while being partly immersed in the fiber suspension received in the vessel 2. As shown in FIG. 1, the rotor unit 6 may be provided with four such filter elements 11. However, it should be understood that the disc filter 1 may contain fewer than four filter elements or, alternatively greater than 4 filter elements. In embodiments, each filter element 11 may be perpendicular to the longitudinal axis of the rotor shaft 7. The longitudinal axis coincides with the shaft axis of rotation 131 of the rotor shaft 7 (shown in FIG. 3). Each filter element 11 extends in an annular configuration radially outward from the rotor shaft 7. Each filter element 11 may be divided into several filter sectors 12 distributed about the rotor shaft 7. The filter sectors 12 of an individual filter element 11 may be mutually separated by means of radially oriented partitions extending between the opposite lateral surfaces of the filter element 11. As shown, the filter sectors 12 may be separated by radially oriented partitions. However, it should be understood that the partitions can be arranged in a variety of positions other than radial, depending on cost factors and other desirable structurally equivalent orientations. As shown, each filter element 11 may be provided with an external filtering lining 13 (illustrated by the screen pattern in FIG. 2) on its opposite lateral surfaces and internal flow channels (not shown), which communicate with filtrate channels 14 in the rotor shaft 7 to convey filtrate that passes through the filtering lining 13 to said filtrate channels 14. It is noted that a variety of equivalent filtering lining dispositions may be used in addition to the external dispositions shown in the drawings.

Referring again to FIG. 2, each individual filter sector 12 may comprise a conduit section 15 for transferring the filtrate, i.e. the liquid filtered out of the fiber suspension in the vessel 2, from the filter sector 12 into an associated filtrate channel 14 in the rotor shaft 7 through an opening provided in the envelop surface of the rotor shaft 7 between the conduit section 15 and the filtrate channel 14.

The filtrate channels 14 may extend in the axial direction of the rotor shaft 7. These filtrate channels 14 may be formed as sector shaped spaces mutually separated by means of radially oriented partition walls extending along the rotor shaft 7. The filtrate channels 14 may be delimited in the radial direction inwards by a tubular core 17 of the rotor shaft 7. The tubular core 17 may have a varying diameter along the length of the rotor shaft 7, with the smallest diameter at the end of the tubular core which is located at that end of the rotor shaft 7 where the filtrate passes out of the rotor shaft 7 in the axial direction thereof. In the illustrated example, two outlets are provided for the filtrate. A first outlet 20 may be intended for a pre-filtrate (cloudy filtrate), whereas the other outlet 21 may be intended for a clear filtrate. At least the clear filtrate outlet 21 and possibly also the pre-filtrate outlet 20 may be connected to a fall tube 24 intended to establish a vacuum in a suction head 22. This suction head 22 may communicate with the filtrate channels 14 in the rotor shaft 7 through a filtrate valve 23. When the rotor shaft 7 rotates in relation to the filtrate valve 23 and the suction head 22, the filtrate valve 23 may bring the respective filtrate channel 14 in communication with the pre-filtrate outlet 20 or the clear filtrate outlet 21 depending on the prevailing rotational position of the rotor shaft 7.

A pressure sensor 416 may be in fluid communication with the filter elements 11 and operable to measure a vacuum pressure of the filter elements 11. For example, a pressure sensor 416 may be provided in suction head 22 such that a vacuum pressure sensed by the pressure sensor 416 is indicative of the vacuum pressure of the filter elements 11. The control system 400 may be communicatively coupled with the pressure sensor 416 and configured to receive a vacuum pressure signal from the pressure sensor 416. If the vacuum pressure signal indicates that the vacuum pressure of the filter elements 11 is too high (i.e., indicating a lower vacuum), the disc filter 1 may not be operating in the right conditions and further action may be taken to reduce or prevent damage to the filter elements 11. For instance, if the fiber material in the fiber suspension is not accumulating on the external filtering lining 13 of the filter elements 11, the rate in which liquid filtrate is removed from the fiber suspension will increase relative to the rate in which fiber material is removed. This will cause the consistency in the fiber suspension to increase which may increase the density and/or viscosity of the fiber suspension. The increased density and/or viscosity of the fiber suspension may cause the filter elements 11 to experience significant shear forces as they rotate through the thickened fiber suspension. Therefore, as discussed in more detail herein, incorporating the pressure sensor 416 in the suction head 22 and using the control system 400 to monitor the vacuum pressure in the suction head 22 via the pressure sensor 416 may provide an early indication of problematic operating conditions which may be acted on prior to system failure (e.g., damage to or breaking of the filter elements 11).

Referring again to FIG. 2, the disc filter 1 may further comprise at least one secondary injector 110 which extends through a wall of the vessel 2. The at least one secondary injector 110 may be used to introduce a secondary flow of the fiber suspension into the vessel 2 to promote dilution, agitation, and mixing of the fiber suspension in the vessel, thereby reducing the thickening of the fiber suspension and improving the efficiency of the disc filter 1. Secondary injectors may be positioned at locations to assist in mitigating thickening of the fiber suspension at areas of the vessel 2 most prone to thickening. The design and operational details of secondary injectors in disc filter systems may be found in United States Patent Application Publication No. 2021/0291087, the entire contents of which are incorporated herein by reference. As shown in FIG. 2, a secondary conduit 19 may be connected to the conduit 4. The secondary conduit 19 may receive fiber suspension to be injected into the vessel 2 through the at least one secondary flow injector 110. Optional valves and flow meters along the secondary conduit 19 are not depicted in FIG. 2. Without wishing to be bound by theory, it is believed that the use of secondary injectors 110 may complement the benefits provided by torque-based control of the rotational speed of the rotor shaft 7, as both may be utilized to respond to operating conditions that lead to substantial thickening of the fiber suspension in the vessel in order to prevent damage to the discs and improve operation of the disc filter.

Referring again to FIG. 1, the disc filter 1 may also be provided with loosening members 25 for loosening fiber material that has been filtered out of the fiber suspension in the vessel 2 and deposited as a fiber mat on the filtering linings 13 of respective filter elements 11. In embodiments, the loosening members 25 may be spray nozzles configured to loosen the fiber material deposited on the filtering linings 13 of the filter elements 11 successively from one filter sector 12 at a time as the filter sectors 12 of the filter elements 11 rotate past loosening members 25. The loosening members 25 may be arranged on the opposite sides of each filter element 11 and may emit jets of water or any other suitable fluid emitted from these loosening members 25.

The disc filter 1 may be also be provided with cleaning members 26 for cleaning the filtering linings 13 of respective filter elements 11 with a flushing liquid emitted from the cleaning members 26. In embodiments, the cleaning members 26 may be spray nozzles arranged on the opposite sides of each filter element 11. The cleaning members 26 may be configured to emit jets of water or any other suitable flushing liquid towards the filtering lining 13 on the opposite sides of each filter element 11. The cleaning members 26 may be suitably mounted on pivotable carriers 27 configured to pivot back and forth in order to allow the cleaning members 26 to sweep over the filtering lining 13 of the respective filter element 11 during the rotation of the rotor unit 6. The carriers 27 may be pivoted by a drive 29, for instance in the form of a drive motor. The loosening members 25 may be connected to the pivotable carriers 27 in order to make the loosening members 25 pivot together with the cleaning members 26. Alternatively, in embodiments, the loosening members 25 may be stationary. In embodiments, the cleaning members 26 may be located after the loosening members 25 with respect to the rotational direction of the filter elements 11. In such embodiments, the respective filter sector 12 of a filter element 11 will rotate past the loosening members 25 and thereafter past the cleaning members 26 during the rotation of the filter element 11.

The disc filter 1 may comprise a plurality of receiver chutes 30. Each receiver chute 30 may include an inlet opening 38 at the upper end for receiving the fiber mat loosened from the filtering lining 13 of the adjacent filter elements 11. Each filter element 11 has a first receiver chute 30 located alongside of a part of the filtering lining 13 on a first side of the filter element 11 and another receiver chute 30 located alongside of a part of the filtering lining 13 on the opposite side of the filter element 11. One receiver chute 30 may be located in the space between each pair of adjacent filter elements 11 and in the space between the respective outermost filter element 11 on the rotor shaft 7 and the adjacent gable wall of the vessel 2. In embodiments, the receiver chutes 30 may be located in the part of the vessel 2 where the filter sectors 12, during the rotation of the rotor unit 6, are rotated down into the fiber suspension from a position above the fiber suspension, such as on the side of the rotor shaft 7 where the filter sectors 12 are rotated downwards after having the fiber mat liberated therefrom and after being cleaned by the cleaning members 26. That is, the receiver chutes 30 may be located on the side of the vessel 2 where a primary component of the angular velocity of the filter elements 11 is in the downward vertical direction.

However, in alternative embodiments (not shown), the receiver chutes 30 may be located in the part of the vessel 2 where the filter sectors 12, during the rotation of the rotor unit 6, are rotated out of the fiber suspension from a position below the fiber suspension, i.e. on the side of the rotor shaft 7 where the filter sectors 12 are rotated upwards. That is, in alternative embodiments, the receiver chutes 30 may be located on the side of the vessel 2 where a primary component of the angular velocity of the filter elements 11 is in the upward vertical direction. The inlet opening 38 at the upper end of each receiver chute 30 may be located above a horizontal plane extending through the longitudinal axis of the rotor shaft 7, and the lateral edges of said inlet opening 38 extend closely to the filtering linings 13 of the adjacent filter elements 11 in order to efficiently catch the fiber mat loosened from the filter sectors 12 of these filter elements 11. The lateral walls of each receiver chute 30 may diverge at the upper part of the receiver chute 30 close to the inlet opening 38 of the receiver chute, as illustrated in FIG. 1. The inlet opening 38 may receive the fiber mat loosened from the filtering lining 13 of adjacent filter elements 11 together with flushing liquid from the cleaning members 26. Furthermore, each receiver chute 30 may be provided with a part 31 at its upper end which is curved inwards into the area above the rotor shaft 7, as illustrated in FIG. 2, so as to allow the inlet opening 38 of the receiver chute 30 to extend into this area.

The loosening members 25 and the cleaning members 26 may be located above the receiver chutes 30 on the side of the rotor shaft 7 where the filter sectors 12 are rotated downwards towards the surface of the fiber suspension in the vessel 2. The cleaning members 26 may be configured to flush the fiber mat loosened by the loosening members 25 down into the receiver chutes 30 by means of the flushing liquid emitted from the cleaning members 26. The receiver chutes 30 may be configured to receive said fiber mat together with flushing liquid from the cleaning members 26 to thereby allow the fiber mat to be diluted in the receiver chutes 30 to a desired consistency by means of this flushing liquid. At the lower end 32, each receiver chute 30 may be connected to a conveyor 33, which may be configured to pick up the fiber mat falling down through the receiver chutes 30 and transfer this fiber mat to an outlet 34 (see FIG. 1), from which the fiber mat may be passed on for further processing. In the illustrated example, said conveyor 33 is a screw conveyor, which extends in parallel with the rotor shaft 7 and which may be rotated by means of a drive 35, for instance in the form of a drive motor.

During operation of the disc filter 1, the fiber suspension is introduced to the vessel 2 through inlet 3. Prior to being introduced to the vessel 2, the fiber suspension may be mixed with dilution liquid to adjust the consistency of the fiber suspension, which in turn, adjusts the consistency of the fiber suspension in the vessel 2 when the fiber suspension is introduced. As previously discussed, the drive 10 may rotate the rotor unit 6 which in turn rotates the filter elements 11 mounted to the rotor shaft 7 of the rotor unit 6. When the filter elements 11 are rotated, the filter sectors 12 are submerged into the fiber suspension in the vessel 2 in the spaces 36 between the receiver chutes 30 and then moved through the fiber suspension to the opposite side of the rotor shaft 7, where the filter sectors 12 are rotated upwards out of the fiber suspension. As the filter sectors 12 move through the fiber suspension, liquid is sucked from the fiber suspension, through the filtering lining 13 on the filter sectors 12 and into the flow channels inside the filter sectors 12, while fiber material is deposited as a fiber mat on the external surfaces of said filtering lining 13. The filtrate comprising the liquid then flows from the flow channels to the filtrate channels 14 in the rotor shaft 7 through the conduit sections 15 and is discharged from the vessel 2 through the suction head 22 and one of the pre-filtrate outlet 20 or the clear filtrate outlet 21.

When the filter sectors 12 have been rotated upwards out of the fiber suspension, the continued suction through the filtrate channels 14 in the rotor shaft 7 and the flow channels in the filter sectors 12 creates an air flow through the fiber material deposited on the filtering lining 13 of the filter sectors 12 and further on through the flow channels and into the filtrate channels 14. The fiber material deposited on the filtering lining 13 may be subjected to drying by this air flow. After having rotated past the angular position in which the filter sectors 12 are orientated vertically upwards, the filter sectors 12 may successively rotate past the loosening members 25, which loosen the fiber mat from the filtering lining 13 of the filter sectors 12 by means of fluid jets directed towards the opposite lateral surfaces of the respective filter sector 12. Upon continued rotation of the rotor unit 6 the filter sectors 12 may then rotate past the cleaning members 26, which clean the filtering lining 13 of the filter sectors 12 by means of flushing liquid sprayed towards the opposite lateral surfaces of the respective filter sector 12. The fiber mat loosened from the filtering lining 13 of the filter sectors 12 falls down into the receiver chutes 30 together with flushing liquid from the cleaning members 26. At the bottom of the receiver chutes 30, the fiber mat may be picked up by the conveyor 33 and passed on for further processing. After having rotated past the cleaning members 26 and the upper ends of the receiver chutes 30, the filter sectors 12 are rotated down into the fiber suspension again for continued filtering of the fiber suspension.

Referring now to FIG. 3, the disc filter system 100 may comprise a fiber suspension source 200 (e.g., a storage tank or the like) containing an input fiber suspension and coupled to a primary pump 120 that may be operable to provide a flow of the input fiber suspension from the fiber suspension source 200 to the inlet 3 of the disc filter 1 through the conduit 4. In embodiments of the disc filter system 100 comprising at least one secondary injector 110, a secondary conduit 19 may be connected to the conduit 4 such that the primary pump 120 is also operable to provide a flow of the input fiber suspension from the fiber suspension source 200 to the at least one secondary flow injector 110. As such, the characteristics of the fiber suspension delivered to the inlet 3 may the same as those for the fiber suspension delivered to the at least secondary injector 110, if present. As discussed in more detail herein, the fiber suspension introduced to the vessel 2 via the inlet 3 may comprise a mixture of the input fiber suspension, which is supplied from the fiber suspension tank, and a dilution liquid. In embodiments, a primary feed valve 122 may be disposed between the primary pump 120 and the inlet 3 to regulate the flow rate and pressure of fiber suspension to the inlet 3, as depicted in FIG. 3. In embodiments, the disc filter system 100 may include a primary feed flow meter 124 disposed between the primary pump 120 and the inlet 3. The primary feed flow meter 124 may be used to monitor the flow rate and/or pressure of the fiber suspension supplied to the inlet 3 by the primary pump 120.

It has been unexpectedly found that providing a secondary flow of liquid into the vessel 2 such that the secondary flow contacts the rotor shaft 7 causes sufficient agitation and mixing in the vessel opposite the inlets 3 to further reduce or mitigate thickening of the fiber suspension in the vessel. In particular, when the secondary flow of liquid (indicated in FIG. 3 by primary flow vector 111) contacts the rotor shaft 7, the secondary flow is redirected and scattered in multiple directions (i.e., vertically and directions between vertical and horizontal). This redirection and scattering of the secondary flow by the rotor shaft 7 creates agitation and mixing of the fiber suspension resident in the vessel 2 which assists in both diluting the suspension resident in the vessel 2 and creating a more homogenous mix of filtrate and fiber, thereby reducing or even mitigating thickening and the resultant effect of mechanical scraping against the filter mat deposited on the filter elements 11. Advantageously, it has been found that the agitation and mixing due to the secondary flow of liquid directed onto the rotor shaft 7 does not disrupt the deposition of the fiber mat on the filter elements 11.

With continued reference to FIG. 3, in embodiments, the secondary conduit 19 may deliver fiber suspension from the conduit 4 to a feed manifold 108. Each of the at least one secondary injector 110 may be coupled to the feed manifold through an injector valve 112. The injector valves 112, when included, may be used to regulate and adjust the flow and pressure of liquid to and through each of the injectors from the feed manifold 108. For example, the injector valves 112 may be used to individually regulate the flow rate and pressure of liquid to and through each of the injectors 110. Accordingly, it should be understood that, in some embodiments, the flow and/or pressure of liquid through each of the injectors 110 may be individually regulated. In some embodiments, the injector valves 112 may be manually operated while, in other embodiments, the injector valves 112 are electrically or pneumatically operated such that the injector valves 112 can be remotely actuated by a control system 400 or the like communicatively coupled to the injector valves 112 (communicative couplings between injector valves 112 and 400 not shown in FIG. 3). In such embodiments, the primary pump 180 may also be communicatively coupled to the control system 400 such that the flow rate and pressure of liquid into and through the injectors 110 can be remotely controlled and/or regulated.

In embodiments, each of the injectors 110 may be coupled to the feed manifold 108 with an injector flow meter 114. In embodiments in which the injectors 110 are coupled to the feed manifold 108 with injector valves 112, the injector flow meters 114 are positioned between the injector valves 112 and the injectors 110, as depicted in FIG. 3. The injector flow meters 114 may be used to monitor the flow and/or pressure of liquid from the feed manifold 108 to the injectors 110. The injector flow meters 114 may be communicatively coupled to the control system 400 (communicative couplings between injector flow meters 114 and control system 400 not shown in FIG. 3) thereby enabling automated monitoring of the flow and/or pressure of liquid to and through the injectors 110. In some of these embodiments, such as embodiments which include both injector flow meters 114 and/or injector valves 112, the control system 400 may use the injector flow meters 114 in conjunction with the injector valves 112 and/or the primary pump 120 to facilitate feedback control of the flow and pressure of liquid through the injectors 110.

In embodiments, a secondary conduit feed valve 142 may be disposed between the feed manifold 8 and the connection point between the conduit 4 and the secondary conduit 19 to regulate the flow rate and pressure of fiber suspension to the secondary injectors 110, as depicted in FIG. 3. In embodiments, the disc filter system 100 may include a secondary conduit flow meter 144 between the feed manifold 8 and the connection point between the conduit 4 and the secondary conduit 19. The secondary conduit flow meter 144 may be used to monitor the flow rate and/or pressure of the fiber suspension supplied to the secondary injectors 110 via the feed manifold 108.

In embodiments, the secondary conduit 19 may deliver fiber suspension from the conduit 4 directly to the at least one secondary injector 110. In embodiments, the feed manifold 108, the injector valves 112, the injector flow meters 114, the secondary conduit feed valve 142, and the secondary conduit flow meter 144 may be omitted from the disc filter system 100, individually or in any combination.

The disc filter system 100 may also comprise a dilution liquid source 300 (e.g., a storage tank, water treatment process, or the like) containing a dilution liquid and coupled to a secondary pump 130 that may be operable to provide a flow of the dilution liquid from the dilution liquid source 300 through dilution conduit 301 to the conduit 4. In this manner, the input fiber suspension pumped from the fiber suspension source 200 may be diluted, i.e., so as to reduce the consistency of the fiber suspension, prior to supplying the fiber suspension to the disc filter 1 through inlet 3. In embodiments, the dilution conduit 301 carrying the dilution liquid may intersect the conduit 4 such that dilution liquid can be mixed with the input fiber suspension flowing through the conduit 4. In embodiments, the dilution liquid and input fiber suspension may be mixed together in the conduit 4 and in the vessel 2 to produce a homogenous fiber suspension. In embodiments, the dilution liquid and the input fiber suspension may also be combined in a separate system component, such as a mixing tank or other system component that is disposed upstream of the vessel 2 and able to achieve the desired dilution of the fiber suspension flowing into the disc filter through inlet 3.

In embodiments, a dilution control valve 132 may be disposed in dilution conduit 310 between the secondary pump 130 and the intersection of the dilution conduit 310 and conduit 4. The dilution control valve 132 may be operable to regulate the flow rate and pressure of dilution liquid to the conduit 4. In embodiments, the disc filter system 100 may include a dilution liquid flow meter 134 disposed in the dilution conduit 310 between the secondary pump 130 and the intersection of the dilution conduit 310 and conduit 4. The dilution liquid flow meter 134 may be operable to monitor the flow rate and/or pressure of the dilution liquid supplied to the conduit 4 by the secondary pump 130.

In embodiments, the primary feed valve 122, the dilution control valve 132, or both may be manually operated valves. In embodiments, the primary feed valve 122, the dilution control valve 132, or both may be control valves that can be electrically or pneumatically actuated. The primary feed valve 122, the dilution control valve 132, or both may be communicatively coupled to the control system 400. In embodiments, the primary pump 120, the dilution liquid pump 130, or both may be communicatively coupled to the control system 400 such that the flow rate and/or pressure of the fiber suspension (in both diluted and undiluted states) to the inlet 3 and/or the dilution liquid to the conduit 4, respectively, can be controlled and/or regulated by the control system 400. The primary feed flow meter 124, the dilution liquid flow meter 134, or both may be communicatively coupled to the control system 400 thereby enabling automated monitoring of the flow rate and/or pressure of the fiber suspension to the inlet 3 and/or the dilution liquid to the conduit 4, respectively. In embodiments, the control system 400 may send control signals to one or more of the primary feed valve 122, the dilution control valve 132, the primary pump 120, the dilution liquid pump 130, or combinations of these and may receive signals from the primary feed flow meter 124, and dilution liquid flow meter 134, or both to facilitate feedback control of the flow rate of the fiber suspension to the inlet 3 and the dilution liquid to the conduit 4.

Referring again to FIG. 3, the control system 400 may include at least one processor 402, at least one memory module 404 communicatively coupled to the processor 402, and machine readable and executable instructions 406 stored on the memory module(s) 404. The machine readable and executable instructions 406, when executed by the processor 402, may cause the disc filter system 100 to automatically execute any of the method steps described herein. The control system 400 may be communicatively coupled to the disc filter system 100 by being communicatively coupled to one or more of the drive 10, the primary pump 120, the secondary pump 130, the primary feed valve 122, the dilution control valve 132, the secondary conduit feed valve 142, the injector valves 112, the primary feed flow meter 124, the dilution liquid flow meter 134, the secondary conduit flow meter 144, the injector flow meters 114, the fill level sensor 412, the torque measurement device 414, the pressure sensor 416, or combinations of these. The control system 400 may be communicatively coupled with one or more other sensors or control devices related to the operation of the disc filter.

Control strategies for operation of the disc filter system 100 will now be discussed in further detail. It should be understood that while each control strategy is discussed individually for purposes of clarity, any of the measurement devices and control strategies may be combined with any of the other measurement devices and control strategies to control the disc filter system 100 in response to changes in operation of the disc filter 1. Additionally, any of the control strategies disclosed herein can be implemented through the control system 400 using machine readable and executable instructions 406 stored on the at least one memory module 404 of the control system 400 and executed by the processor 402 of the control system 400.

With continued reference to FIG. 3, the machine readable and executable instructions 406, when executed by the processor 402, may cause the disc filter system 100 to automatically measure the torque on the drive 10 and adjust the rotational speed of the rotor shaft 7, via the drive 10, from a first rotational speed to a second rotational speed based on the torque on the drive, where the second rotational speed is different from the first rotational speed and is greater than zero. In measuring the torque on the drive 10, the control system 400 may receive a torque signal from the torque measurement device 414 that corresponds to the torque on the drive 10. The first rotational speed and the second rotational speed may be non-zero. In embodiments, the second rotational speed is greater than the first rotational speed such that the rotational speed of the filter elements 11 increases based on the torque measured on the drive 10. In embodiments, the second rotational speed is less than the first rotational speed such that the rotational speed of the filter elements 11 decreases based on the torque measured on the drive 10. In embodiments, the rotational speed may be increased in response to increasing torque and decreased in response to decreasing torque.

In embodiments, the machine readable and executable instructions 406, when executed by the processor 402, may further cause the disc filter system 100 to automatically determine whether the torque on the drive 10 is greater than a high threshold torque for the drive 10. When the torque on the drive 10 is greater than the high threshold torque for the drive 10, the disc filter system 100 may increase the rotational speed of the rotor shaft 7, via the drive 10, from the first rotational speed to the second rotational speed, wherein the second rotational speed is greater than the first rotational speed. In embodiments, the high threshold torque on the drive 10 may be a torque that is less than or equal to 95% of the maximum torque, less than or equal to 90% of the maximum torque, less than or equal to 80% of the maximum torque, less than or equal to 70% of the maximum torque, less than or equal to 60% of the maximum torque, or less than or equal to 50% of the maximum torque, where the maximum torque is the torque above which the torque continues to increase rapidly without intervention, which leads to damaging the filter elements 11. The maximum torque may depend at least in part on the properties of the fiber suspension and operating conditions of the disc filter. The maximum torque may be the greatest torque in which the drive 10 can be operated according to the drive's specifications. In embodiments, the high threshold torque on the drive 10 may be a torque that is greater than or equal to 50% and less than or equal to 95% of the maximum torque, greater than or equal to 60% and less than or equal to 95% of the maximum torque, greater than or equal to 70% and less than or equal to 95% of the maximum torque, greater than or equal to 80% and less than or equal to 95% of the maximum torque, greater than or equal to 90% and less than or equal to 95% of the maximum torque, or greater than or equal to 95% and less than or equal to 99% of the maximum torque.

As discussed above, in embodiments, the control system 400 may implement a PID control scheme to maintain the torque on the drive 10 at a torque setpoint by controlling the rotational speed of the rotor shaft 7. In embodiments, the torque setpoint may depend on the conditions of the fiber suspension in the vessel 2 of the disc filter. In embodiments, the high threshold torque on the drive 10 may be a torque that is greater than or equal to 105% of the torque setpoint and less than or equal to 95% of the maximum torque, greater than or equal to 110% of the torque setpoint and less than or equal to 95% of the maximum torque, greater than or equal to 120% of the torque setpoint and less than or equal to 95% of the maximum torque, greater than or equal to 130% of the torque setpoint and less than or equal to 95% of the maximum torque, greater than or equal to 140% of the torque setpoint and less than or equal to 95% of the maximum torque, or greater than or equal to 150% of the torque setpoint and less than or equal to 95% of the maximum torque. Running the disc filter system 100 at a constant motor torque may enable detection of increasing friction on the filter elements 11 and/or prevent of increasing friction on the filter elements 11. Changing the rotational speed of the filter elements 11 to maintain the motor torque constant may also enable the control system 400 to reduce or prevent high lateral (i.e., axial relative the center axis of the rotor shaft) forces on the filter elements 11. The torque set point may be selected to reduce or prevent these high axial forces caused by the consistency of the fiber suspension in the vessel 12 being too high.

It has been found that the performance of the disc filter system 100 may be improved by increasing the rotational speed of the filter elements 11 in situations in which the fiber suspension comprises elevated consistency. In particular, it has been found that increasing the rotational speed of the filter elements 11 may cause the fiber material removal rate to increase relative to the filtrate removal rate. The consistency of the fiber suspension in the vessel 2 can therefore be decreased by increasing the rotational speed of the filter elements 11. Such a control strategy is counterintuitive because an increased torque on the drive 10, caused for example, by an increased consistency in the fiber suspension, may suggest that the rotational speed of the filter elements 11 should be decreased to avoid excessive shear forces on the filter elements 11 which could result in damage to the filter elements 11. In other words, it might be expected that the drive used to rotate the rotor unit of a disc filter should be turned off when a predetermined torque level is reached. However, in the control methods of the present application, control system 400 may increase the rotational speed of the rotor shaft 7 of the disc filter 1 in response to a predetermined torque level being reached. In embodiments wherein the control system 400 implements PID control to maintain the torque on the drive 10 at a torque setpoint by controlling the rotational speed of the rotor shaft 7, the magnitude of the increase in the rotational speed of the rotor shaft 7 may depend on PID tuning parameters set to achieve the desired control behavior.

In embodiments, such as those implementing PID control, the rotational speed of the rotor shaft 7 may be continuously adjusted by the control system 400 based on the torque on the drive 10 as well as other measured variables of the disc filter system 100 (discussed below). By continuously adjusting the rotational speed of the rotor shaft 7, the disc filter system 100 may protect the filter elements 11 from making contact with other components in the vessel 2 such as the lateral walls of the receiver chutes 30 or inlet channels 40, while also achieving a high energy efficiency for the separation process. Furthermore, it should be understood that the additional control variables introduced below may also be continuously adjusted in response to the torque on the drive 10 as well as other measured variables of the disc filter system 100.

In embodiments, the control system 400 may be configured to monitor the fill level in the vessel 2 and increase or decrease the flow rate of dilution liquid to the conduit 4, the flow rate of the fiber suspension to the vessel 2, the flow rate of the fiber suspension to the secondary injectors 110, or any combination of these based on the fill level. In embodiments, the control system 400 may implement a PID control scheme to maintain the fill level in the vessel 2 at a fill level setpoint by controlling the flow rate of dilution liquid to the conduit 4, the flow rate of the fiber suspension to the vessel 2, the flow rate of the fiber suspension to the secondary injectors 110, or any combination of these.

In embodiments, the control system 400 may be configured to control the operation of the disc filter 1 in response to the torque on the drive 10 in combination with the fill level of the fiber suspension in the vessel 2. As the rotational speed of the rotor shaft 7 increases, the rate in which fiber material and the filtrate exit the disc filter 1 may also increase, which may cause the fill level of the fiber suspension in the vessel 2 to decrease. If the level of the fiber suspension in the vessel 2 falls below a low level setpoint, a portion of the filter sectors 12 may be exposed in rotational positions where they would normally be submerged in the fiber suspension, which may reduce the efficiency of the disc filter 1 for dewatering the fiber suspension. In addition to decreasing the consistency of the fiber suspension in the vessel 2 by increasing the rotational speed of the rotor shaft 7, the consistency of the fiber suspension can be further decreased by diluting the fiber suspension introduced into the vessel 2 through inlet 3.

In embodiments, when the torque on the drive 10 is greater than the high threshold torque for the drive 10, the machine readable and executable instructions 406, when executed by the processor 402, may increase the rotational speed of the rotor and may further cause the disc filter system 100 to automatically measure the fill level of the fiber suspension in the vessel 2 and determine whether the fill level of the fiber suspension in the vessel 2 is less than the low level setpoint of the fiber suspension in the vessel 2. In measuring the fill level of the fiber suspension in the vessel 2, the control system 400 may receive a fill level signal from the fill level sensor 412 that corresponds to the fill level of the fiber suspension in the vessel 2. In embodiments, when the fill level of the fiber suspension in the vessel 2 is less than the low level setpoint, the control system 400 may cause the disc filter system 100 to increase the fill level of the fiber suspension in the vessel 2 by increasing the flow rate of the dilution liquid to the conduit 4, the flow rate of the input fiber suspension to the vessel 2, or both. In embodiments, when the fill level of the fiber suspension is less than the low level setpoint of the fiber suspension, the disc filter system 100 may dilute the fiber suspension in the vessel 2. In embodiments, the disc filter system 100 may dilute the fiber suspension at a point upstream from the inlet 3. In embodiments, the low level setpoint of the fiber suspension in the vessel 2 may be determined so as to improve the operation of the disc filter. It has been found that a lower low level setpoint tends to result in a lower vacuum (e.g., greater absolute pressure) thereby reducing the rate of filtrate extraction and the rate in which the disc filter system 100 is able to separate the fiber material from the filtrate of the fiber suspension. In embodiments, the low level setpoint may be determined based on the conditions of the fiber suspension and/or operational conditions of the disc filter system 100.

In embodiments, when the rotational speed of the rotor shaft 7 is increased in response to a predetermined torque level being reached, the machine readable and executable instructions 406, when executed by the processor 402, may further cause the disc filter system 100 to automatically monitor the torque level and determine if the torque level remains at or above the high threshold torque value despite the increased rotational speed of the rotor shaft 7. If the torque remains at or above the high threshold torque level, the control system 400 may cause disc filter system 100 to increase the flow rate of the dilution liquid to the conduit 4. In such embodiments, the increased rotational speed of the rotor shaft 7 and increased flow rate of the dilution liquid to the conduit 4 may work in conjunction to decrease the consistency of the fiber suspension in the disc filter 1.

In embodiments, the control system 400 may cause the disc filter system 100 to dilute the fiber suspension by sending a control signal to the dilution control valve 132 that increases the flow rate of dilution liquid from the dilution liquid source 300 to the conduit 4 through which the fiber suspension may be supplied to the inlet 3. In this manner, the fiber suspension may be diluted at a point upstream from the inlet 3.

As discussed herein, the control system 400 may be communicatively coupled with the pressure sensor 416, which is fluidly coupled to the filter elements 11 and operable to measure a vacuum pressure of the at least one of filter element 11.

The control system 400 may be configured to monitor the vacuum pressure of the at least one filter element 11 and increase or decrease the rotational speed of the rotor shaft 7, via the drive 10, based on the vacuum pressure of the at least one filter element 11. The control system 400 may also be configured to increase or decrease the flow rate of dilution liquid to the conduit 4 based on the vacuum pressure of the at least one filter element 11. The control system 400 may also be configured to increase or decrease the flow rate of fiber suspension to the vessel 2 based on the vacuum pressure of the at least one filter element 11. The adjustment of the rotational speed of the rotor unit 7, the flow rate of the dilution liquid to the conduit 4, and the flow rate of the fiber suspension to the vessel 2, may be performed independently or in any combination, as a function of the vacuum pressure of the at least one filter element 11.

In embodiments, the control system 400 may control the operation of the disc filter 1 in response to the torque measured on the drive 10 in combination with a vacuum pressure measured for the at least one filter element 11.

In embodiments, when the torque on the drive 10 is greater than the high threshold torque for the drive 10 and the rotational speed of the rotor shaft 7 has been adjusted to the second rotational speed as a result, the machine readable and executable instructions 406, when executed by the processor 402, may further cause the disc filter system 100 to automatically monitor the length of time that the rotational speed of the rotor shaft 7 is set to the second rotational speed and determine whether the length of time that the rotational speed of the rotor shaft 7 is set to the second rotational speed exceeds a threshold length of time for the second rotational speed. When the length of time that the rotational speed of the rotor shaft 7 is set to the second rotational speed exceeds the threshold length of time for the second rotational speed, the control system 400 may cause the disc filter system 100 to measure the vacuum pressure of the at least one of filter element 11 and determine whether the vacuum pressure of the at least one filter element 11 is greater than a high threshold vacuum pressure of the at least one filter element 11. A significant spike in vacuum pressure, e.g., above the high threshold vacuum pressure, indicates that the filter elements 11 do not have adequate levels of fiber deposited thereon when they emerge from the fiber suspension in the vessel 2. In this circumstance, filtrate may quickly be extracted from the fiber suspension and an accumulation of fiber material may develop in the vessel 2, which may require the disc filter system 100 to be shut down to avoid damage to the filter elements 11. Moreover, as fiber material accumulates in the vessel 2, the torque on the drive 10 may increase. When the torque on the drive 10 exceeds a drive torque tripping value, the disc filter system 100 may be shut down to avoid damage to the filter elements 11. In embodiments wherein the control system 400 implements PID control schemes, the threshold length of time for the second rotational speed may depend on the PID tuning parameters set to achieve the desired control behavior.

Further, when (i) the length of time that the rotational speed of the rotor shaft 7 is set to the second rotational speed exceeds the threshold length of time for the second rotational speed and (ii) the vacuum pressure of the at least one of filter element 11 is greater than the high threshold vacuum pressure of the at least one filter element 11, the control system 400 may cause the disc filter system 100 to shut down to prevent damage to the system. In embodiments, the high threshold vacuum pressure of the at least one filter element 11 may be greater than 90% of the maximum vacuum pressure, greater than 80% of the maximum vacuum pressure, greater than 70% of the maximum vacuum pressure, greater than 60% of the maximum vacuum pressure, greater than 50% of the maximum vacuum pressure, greater than 40% of the maximum vacuum pressure, greater than 30% of the maximum vacuum pressure, or greater than 20% of the maximum vacuum pressure, where the maximum vacuum pressure is the vacuum pressure above which the torque continues to increase without intervention, eventually leading to damage to the filter elements 11. The maximum vacuum pressure may depend at least in part on the properties of the fiber suspension and operating conditions of the disc filter. As discussed herein, a weak vacuum on the filter elements 11 (i.e., a vacuum pressure greater than the high threshold vacuum pressure) may indicate that the disc filter 1 is not operating in the right conditions and needs to be shut down. Therefore, by monitoring the vacuum pressure of the filter elements 11 and shutting down the disc filter system 100 (if the above conditions are met), the potential for damage to the disc filter 1 can be reduced.

In embodiments, when the torque on the drive 10 is greater than the high threshold torque for the drive 10 and the rotational speed of the rotor shaft 7 has been adjusted to the second rotational speed as a result, the machine readable and executable instructions 406, when executed by the processor 402, may further cause the disc filter system 100 to automatically to monitor the vacuum pressure of the at least one filter element and determine whether the vacuum pressure is above the high threshold vacuum pressure. Further, if the vacuum pressure is greater than the high threshold vacuum pressure, the disc filter system 100 may measure a length of time that the vacuum pressure is greater than the high threshold vacuum pressure and determine whether the length of time that the vacuum pressure is greater than the high threshold vacuum pressure is greater than a threshold length of time for high vacuum pressure. In embodiments, the threshold length of time for high vacuum pressure may be determined based on the conditions of the fiber suspension and/or operational conditions of the disc filter system 100.

Further, when the length of time that the vacuum pressure is greater than the high threshold vacuum pressure is greater than the threshold length of time for high vacuum pressure, the control system 400 may cause the disc filter system 100 to shut down to prevent damage to the system. By monitoring the length of time that the vacuum pressure is above the high threshold vacuum pressure, the control method of the present embodiment may not be as sensitive to temporary drops in vacuum, i.e., temporary spikes in the vacuum pressure, which may occur during normal operating conditions.

In embodiments, when the torque on the drive 10 is greater than the high threshold torque for the drive 10, the machine readable and executable instructions 406, when executed by the processor 402, may further cause the disc filter system 100 to automatically measure the vacuum pressure of the at least one of filter element 11 and determine if the vacuum pressure of the at least one filter element 11 is less than a low threshold vacuum pressure of the at least one filter element 11. Further, when (i) the torque on the drive 10 is greater than the high threshold torque for the drive 10 and (ii) the vacuum pressure of the at least one of filter element 11 is less than the low threshold vacuum pressure of the at least one filter element 11, the control system 400 may cause the disc filter system 100 to increase the rotational speed of the rotor shaft 7, via the drive 10, from the first rotational speed to the second rotational speed, wherein the second rotational speed is greater than the first rotational speed.

In embodiments, the machine readable and executable instructions 406, when executed by the processor 402, may further cause the disc filter system 100 to automatically decrease the rotational speed of the rotor shaft 7 when (i) the torque on the drive 10 decreases to less than a low threshold torque for the drive 10, (ii) the vacuum pressure of the at least one filter element 11 is greater than the high threshold vacuum pressure of the at least one filter element 11, or (iii) both conditions are met. In embodiments, the low threshold torque may be greater than or equal to 5% and less than or equal to 50% of the maximum torque, greater than or equal to 5% and less than or equal to 45% of the maximum torque, greater than or equal to 5% and less than or equal to 40% of the maximum torque, greater than or equal to 5% and less than or equal to 35% of the maximum torque, greater than or equal to 5% and less than or equal to 30% of the maximum torque, greater than or equal to 5% and less than or equal to 25% of the maximum torque, greater than or equal to 5% and less than or equal to 20% of the maximum torque, greater than or equal to 5% and less than or equal to 15% of the maximum torque, or greater than or equal to 5% and less than or equal to 10% of the maximum torque. In embodiments, the low threshold torque on the drive 10 may depend on the conditions of the fiber suspension in the disc filter system 100. In embodiments, the rotational speed of the rotor shaft 7 may be decreased by an amount determined based on the conditions of the fiber suspension and/or operational conditions of the disc filter system 100.

In embodiments, the control system 400 may cause the disc filter system 100 to increase the consistency of the fiber suspension by sending a control signal to the dilution control valve 132 that decreases the flow rate of dilution liquid from the dilution liquid source 300 to the conduit 4 through which the fiber suspension may be supplied to the inlet 3. In this manner, the consistency of the fiber suspension may be increased at a point upstream from the inlet 3.

It should be understood that while embodiments of the present disclosure involve the control system 400, in response to the torque on the drive 10 being greater than a high threshold torque or lower than a low threshold torque, automatically measuring the fill level of the fiber suspension in the vessel 2 and/or the vacuum pressure of the at least one filter element 11, the fill level and the vacuum pressure may be continuously monitored by the control system 400.

In should be understood that with regards to the various threshold values for measured variables of the present disclosure, the particular threshold values will depend on the type of fiber suspension to be processed in the disc filter, the size of the disc filter, and the desired operating conditions and/or performance of the disc filter.

Embodiments of the disclosure may be embodied in hardware and/or in software (including firmware, resident software, micro-code, etc.). The control system 400 of the disc filter system 100 may include the at least one processor 402 and the computer-readable storage medium (i.e., memory module 404) as previously described in this specification. The control system 400 may be communicatively coupled to other components of the disc filter system 100 via any wired or wireless communication pathway. A computer-usable or the computer-readable storage medium or one or more memory modules 404 may be any medium that can contain, store, communicate, propagate, or transport the program for use by or in connection with the instruction execution system, apparatus, or device.

The computer-usable or computer-readable storage medium or memory module(s) 404 may be, for example but not limited to, an electronic, magnetic, optical, electromagnetic, infrared, or semiconductor system, apparatus, device, or propagation medium. More specific examples (a non-exhaustive list) of the computer-readable storage medium or memory module(s) 404 would include but are not limited to the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CD-ROM), and a cloud storage medium, as non-limiting examples. Note that the computer-usable or computer-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The computer-readable storage medium or memory module(s) 404 may include the machine readable and executable instructions 406 for carrying out operations of the present disclosure. The machine readable and executable instructions 406 may include computer program code that may be written in a high-level programming language, such as but not limited to C or C++, for development convenience. In addition, computer program code for carrying out operations of the present disclosure may also be written in other programming languages, such as, but not limited to, interpreted languages. It is not intended to limit the scope of the disclosure to any particular programming language. Some modules or routines may be written in assembly language or even micro-code to enhance performance and/or memory usage. However, software embodiments of the present disclosure do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

In embodiments, the machine readable and executable instructions, when executed by the processor, further may cause the disc filter system to automatically: determine whether the torque on the variable speed drive is greater than a high threshold torque for the variable speed drive; and when the torque on the variable speed drive is greater than the high threshold torque for the variable speed drive, increase the rotational speed of the rotor shaft, via the variable speed drive, from the first rotational speed to the second rotational speed, wherein the second rotational speed is greater than the first rotational speed.

In embodiments, the control system may be communicatively coupled to a fill level sensor, which may be coupled to the vessel and operable to measure a fill level of the fiber suspension in the vessel, and the machine readable and executable instructions, when executed by the processor, may cause the disc filter system to automatically, when the torque on the variable speed drive is greater than the high threshold torque for the variable speed drive: measure the fill level of the fiber suspension in the vessel; determine whether the fill level of the fiber suspension in the vessel is less than a threshold fill level of the fiber suspension in the vessel; and when the fill level of the fiber suspension in the vessel is less than the threshold fill level of the fiber suspension in the vessel, dilute the fiber suspension.

In embodiments, the inlet may be connected to a conduit through which the fiber suspension may be supplied to the inlet; the control system may be communicatively coupled to a dilution control valve operable to control a flow rate of dilution liquid from a liquid source to the conduit; and diluting the fiber suspension may comprise increasing the flow rate of dilution liquid from the liquid source to the conduit via the dilution control valve.

In embodiments, the control system may be communicatively coupled to a pressure sensor coupled to the at least one filter element and operable to measure a vacuum pressure of the at least one filter element, and the machine readable and executable instructions, when executed by the processor, may cause the disc filter system to automatically, when the torque on the variable speed drive is greater than the high threshold torque for the variable speed drive: determine whether a time in which the rotational speed of the rotor shaft is set to the second rotational speed exceeds a threshold length of time for the second rotational speed; measure the vacuum pressure of the at least one filter element; determine whether the vacuum pressure of the at least one filter element is greater than a high threshold vacuum pressure of the at least one filter element; and when (i) the time in which the rotational speed of the rotor shaft is set to the second rotational speed exceeds the threshold length of time for the second rotational speed and (ii) the vacuum pressure of the at least one filter element is greater than the high threshold vacuum pressure of the at least one filter element, shut down the disc filter system.

In embodiments, the machine readable and executable instructions, when executed by the processor, may cause the disc filter system to automatically: determine whether the torque on the variable speed drive is less than a low threshold torque for the variable speed drive; measure the vacuum pressure of the at least one filter element; determine whether the vacuum pressure of the at least one filter element is greater than a high threshold vacuum pressure of the at least one filter element; and when (i) the torque on the variable speed drive is less than the low threshold torque for the variable speed drive and (ii) the vacuum pressure of the at least one filter element is greater than the high threshold vacuum pressure of the at least one filter element, decrease the rotational speed of the rotor shaft, via the variable speed drive, from the first rotational speed to the second rotational speed, wherein the second rotational speed may be less than the first rotational speed.

According to a first aspect of the present disclosure, a disc filter system for dewatering fiber suspension includes a disc filter comprising: a vessel comprising an inlet positioned in a wall of the vessel, the inlet being configured to introduce a fiber suspension into the vessel; a rotor shaft comprising a shaft axis of rotation; a variable speed drive operatively coupled to the rotor shaft and configured to rotate the rotor shaft about the shaft axis of rotation; and at least one filter element coupled to the rotor shaft wherein the at least one filter element rotates with the rotor shaft about the shaft axis of rotation. The disc filter system further includes a control system comprising a processor, a memory module communicatively coupled to the processor, and machine readable and executable instructions stored on the memory module, wherein: the control system is communicatively coupled to the variable speed drive and a torque measurement device operable to measure a torque on the variable speed drive; and the machine readable and executable instructions, when executed by the processor, cause the disc filter system to automatically: measure the torque on the variable speed drive; and adjust a rotational speed of the rotor shaft, via the variable speed drive, from a first rotational speed to a second rotational speed that is non-zero and different from the first rotational speed based on the torque on the variable speed drive.

A second aspect includes the first aspect, wherein the second rotational speed is greater than the first rotational speed.

A third aspect includes the first aspect, wherein the machine readable and executable instructions, when executed by the processor, further cause the disc filter system to automatically: determine whether the torque on the variable speed drive is greater than a high threshold torque for the variable speed drive; and when the torque on the variable speed drive is greater than the high threshold torque for the variable speed drive, increase the rotational speed of the rotor shaft, via the variable speed drive, from the first rotational speed to the second rotational speed, wherein the second rotational speed is greater than the first rotational speed.

A fourth aspect includes the third aspect, wherein the control system is further communicatively coupled to a fill level sensor coupled to the vessel and operable to measure a fill level of the fiber suspension in the vessel, and wherein the machine readable and executable instructions, when executed by the processor, further cause the disc filter system to automatically, when the torque on the variable speed drive is greater than the high threshold torque for the variable speed drive: measure the fill level of the fiber suspension in the vessel; determine whether the fill level of the fiber suspension in the vessel is less than a threshold fill level of the fiber suspension in the vessel; and when the fill level of the fiber suspension in the vessel is less than the threshold fill level of the fiber suspension in the vessel, dilute the fiber suspension.

A fifth aspect includes the fourth aspect, wherein: the inlet is connected to a conduit through which the fiber suspension is supplied to the inlet; the control system is further communicatively coupled to a dilution control valve operable to control a flow rate of dilution liquid from a liquid source to the conduit; and diluting the fiber suspension comprises increasing the flow rate of dilution liquid from the liquid source to the conduit via the dilution control valve.

A sixth aspect includes any one of the first through third aspects, wherein: the disc filter further comprises at least one injector positioned in the wall of the vessel, the at least one injector being configured to introduce a secondary flow of fiber suspension into the vessel; and the control system is further communicatively coupled to a fill level sensor coupled to the vessel and operable to measure a fill level of the fiber suspension in the vessel, and wherein the machine readable and executable instructions, when executed by the processor, further cause the disc filter system to automatically: measure the fill level of the fiber suspension in the vessel; determine whether the fill level of the fiber suspension in the vessel is less than a threshold fill level of the fiber suspension in the vessel; and when the fill level of the fiber suspension in the vessel is less than the threshold fill level of the fiber suspension in the vessel, increase a flow rate of the fiber suspension into the vessel by increasing a flow rate of the fiber suspension introduced into the vessel via the inlet, increasing a flow rate of the secondary flow of fiber suspension introduced into the vessel via the at least one injector, or both.

A seventh aspect includes any one of the third through sixth aspects, wherein the control system is further communicatively coupled to a pressure sensor fluidly coupled to the at least one filter element and operable to measure a vacuum pressure of the at least one filter element, and wherein the machine readable and executable instructions, when executed by the processor, further cause the disc filter system to automatically, when the torque on the variable speed drive is greater than the high threshold torque for the variable speed drive: determine whether a length of time that the rotational speed of the rotor shaft is set to the second rotational speed exceeds a threshold length of time for the second rotational speed; measure the vacuum pressure of the at least one filter element; determine whether the vacuum pressure of the at least one filter element is greater than a high threshold vacuum pressure of the at least one filter element; and when (i) the length of time that the rotational speed of the rotor shaft is set to the second rotational speed exceeds the threshold length of time for the second rotational speed and (ii) the vacuum pressure of the at least one filter element is greater than the high threshold vacuum pressure of the at least one filter element, shut down the disc filter system.

An eighth aspect includes either one of the first or sixth aspects, wherein the second rotational speed is less than the first rotational speed.

A ninth aspect includes either one of the first or sixth aspects, wherein the control system is further communicatively coupled to a pressure sensor fluidly coupled to the at least one filter element and operable to measure a vacuum pressure of the at least one filter element, and wherein the machine readable and executable instructions, when executed by the processor, further cause the disc filter system to automatically: determine whether the torque on the variable speed drive is less than a low threshold torque for the variable speed drive; measure the vacuum pressure of the at least one filter element; determine whether the vacuum pressure of the at least one filter element is greater than a high threshold vacuum pressure of the at least one filter element; and when (i) the torque on the variable speed drive is less than the low threshold torque for the variable speed drive and (ii) the vacuum pressure of the at least one filter element is greater than the high threshold vacuum pressure of the at least one filter element, decrease the rotational speed of the rotor shaft, via the variable speed drive, from the first rotational speed to the second rotational speed, wherein the second rotational speed is less than the first rotational speed.

According to a tenth aspect of the present disclosure, a method for dewatering fiber suspension includes introducing a fiber suspension to a disc filter comprising: a vessel comprising an inlet positioned in a wall of the vessel, the inlet being configured to introduce a fiber suspension into the vessel; a rotor shaft comprising a shaft axis of rotation; and at least one filter element coupled to the rotor shaft wherein the at least one filter element rotates with the rotor shaft about the shaft axis of rotation. The method further includes rotating the rotor shaft about the shaft axis of rotation, measuring a torque on a drive used to rotate the rotor shaft about the shaft axis of rotation, and adjusting a rotational speed of the rotor shaft from a first rotational speed to a second rotational speed that is non-zero and different from the first rotational speed based on the torque on the variable speed drive.

An eleventh aspect includes the tenth aspect, wherein the second rotational speed is greater than the first rotational speed.

A twelfth aspect includes the tenth aspect, wherein the method further includes determining whether the torque on the variable speed drive is greater than a high threshold torque for the variable speed drive, and increasing the rotational speed of the rotor shaft from the first rotational speed to the second rotational speed when the torque on the variable speed drive is greater than the high threshold torque for the variable speed drive, wherein the second rotational speed is greater than the first rotational speed.

A thirteenth aspect includes any one of the tenth through twelfth aspects, wherein the method further includes measuring a fill level of the fiber suspension in the vessel, determining whether the fill level of the fiber suspension in the vessel is less than a threshold fill level of the fiber suspension in the vessel, and diluting the fiber suspension when the fill level of the fiber suspension in the vessel is less than the threshold fill level of the fiber suspension in the vessel.

A fourteenth aspect includes the thirteenth aspect, wherein the inlet is connected to a conduit through which the fiber suspension is supplied to the inlet, and wherein diluting the fiber suspension comprises increasing a flow rate of dilution liquid to the conduit.

A fifteenth aspect includes any one of the tenth through twelfth aspects, wherein the disc filter further comprises at least one injector positioned in the wall of the vessel, the at least one injector being configured to introduce a secondary flow of fiber suspension into the vessel, and wherein the method further comprises: measuring a fill level of the fiber suspension in the vessel; determining whether the fill level of the fiber suspension in the vessel is less than a threshold fill level of the fiber suspension in the vessel; and when the fill level of the fiber suspension in the vessel is less than the threshold fill level of the fiber suspension in the vessel, increasing a flow rate of the fiber suspension into the vessel by increasing a flow rate of the fiber suspension introduced into the vessel via the inlet, increasing a flow rate of the secondary flow of fiber suspension introduced into the vessel via the at least one injector, or both.

A sixteenth aspect includes any one of the twelfth through fifteenth aspects, wherein the method further comprises, when the torque on the variable speed drive is greater than the high threshold torque for the variable speed drive: determining whether a length of time that the rotational speed of the rotor shaft is set to the second rotational speed exceeds a threshold length of time for the second rotational speed; measuring a vacuum pressure of the at least one filter element; determining whether the vacuum pressure of the at least one filter element is greater than a high threshold vacuum pressure of the at least one filter element; and shutting down the disc filter when (i) the length of time that the rotational speed of the rotor shaft is set to the second rotational speed exceeds the threshold length of time for the second rotational speed and (ii) the vacuum pressure of the at least one filter element is greater than the high threshold vacuum pressure of the at least one filter element.

A seventeenth aspect includes the tenth aspect or any one of the thirteenth through fifteenth aspects, wherein the second rotational speed is less than the first rotational speed.

An eighteenth aspect includes the tenth aspect or any one of the thirteenth through fifteenth aspects, wherein the method further comprises, when the torque on the variable speed drive is less than a low threshold torque for the variable speed drive: measuring a vacuum pressure of the at least one filter element; determining whether the vacuum pressure of the at least one filter element is greater than a high threshold vacuum pressure of the at least one filter element; and decreasing the rotational speed of the rotor shaft from the first rotational speed to the second rotational speed when (i) the torque on the variable speed drive is less than the low threshold torque for the variable speed drive and (ii) the vacuum pressure of the at least one filter element is greater than the high threshold vacuum pressure of the at least one filter element, wherein the second rotational speed is less than the first rotational speed.

A nineteenth aspect includes any one of the tenth through eighteenth aspects, wherein the drive is a variable speed drive.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A disc filter system for dewatering fiber suspension, the disc filter system comprising:
a disc filter comprising:
a vessel comprising an inlet positioned in a wall of the vessel, the inlet being configured to introduce a fiber suspension into the vessel;
a rotor shaft comprising a shaft axis of rotation;
a variable speed drive operatively coupled to the rotor shaft and configured to rotate the rotor shaft about the shaft axis of rotation; and
at least one filter element coupled to the rotor shaft wherein the at least one filter element rotates with the rotor shaft about the shaft axis of rotation;
a control system comprising a processor, a memory module communicatively coupled to the processor, and machine readable and executable instructions stored on the memory module, wherein:
the control system is communicatively coupled to the variable speed drive and a torque measurement device operable to measure a torque on the variable speed drive; and
the machine readable and executable instructions, when executed by the processor, cause the disc filter system to automatically:
measure the torque on the variable speed drive; and
adjust a rotational speed of the rotor shaft, via the variable speed drive, from a first rotational speed to a second rotational speed that is non-zero and different from the first rotational speed based on the torque on the variable speed drive.

2. The disc filter system of claim 1, wherein the second rotational speed is greater than the first rotational speed.

3. The disc filter system of claim 1, wherein the machine readable and executable instructions, when executed by the processor, further cause the disc filter system to automatically:
determine whether the torque on the variable speed drive is greater than a high threshold torque for the variable speed drive; and
when the torque on the variable speed drive is greater than the high threshold torque for the variable speed drive, increase the rotational speed of the rotor shaft, via the variable speed drive, from the first rotational speed to the second rotational speed, wherein the second rotational speed is greater than the first rotational speed.

4. The disc filter system of claim 3, wherein the control system is further communicatively coupled to a fill level sensor coupled to the vessel and operable to measure a fill level of the fiber suspension in the vessel, and wherein the machine readable and executable instructions, when executed by the processor, further cause the disc filter system to automatically, when the torque on the variable speed drive is greater than the high threshold torque for the variable speed drive:
measure the fill level of the fiber suspension in the vessel;
determine whether the fill level of the fiber suspension in the vessel is less than a threshold fill level of the fiber suspension in the vessel; and
when the fill level of the fiber suspension in the vessel is less than the threshold fill level of the fiber suspension in the vessel, dilute the fiber suspension.

5. The disc filter system of claim 4, wherein:
the inlet is connected to a conduit through which the fiber suspension is supplied to the inlet;
the control system is further communicatively coupled to a dilution control valve operable to control a flow rate of dilution liquid from a liquid source to the conduit; and
diluting the fiber suspension comprises increasing the flow rate of dilution liquid from the liquid source to the conduit via the dilution control valve.

6. The disc filter system of claim 1, wherein:
the disc filter further comprises at least one injector positioned in the wall of the vessel, the at least one injector being configured to introduce a secondary flow of fiber suspension into the vessel; and
the control system is further communicatively coupled to a fill level sensor coupled to the vessel and operable to measure a fill level of the fiber suspension in the vessel, and wherein the machine readable and executable instructions, when executed by the processor, further cause the disc filter system to automatically:
measure the fill level of the fiber suspension in the vessel;
determine whether the fill level of the fiber suspension in the vessel is less than a threshold fill level of the fiber suspension in the vessel; and
when the fill level of the fiber suspension in the vessel is less than the threshold fill level of the fiber suspension in the vessel, increase a flow rate of the fiber suspension into the vessel by increasing a flow rate of the fiber suspension introduced into the vessel via the inlet, increasing a flow rate of the secondary flow of fiber suspension introduced into the vessel via the at least one injector, or both.

7. The disc filter system of claim 3, wherein the control system is further communicatively coupled to a pressure sensor fluidly coupled to the at least one filter element and operable to measure a vacuum pressure of the at least one filter element, and wherein the machine readable and executable instructions, when executed by the processor, further cause the disc filter system to automatically, when the torque on the variable speed drive is greater than the high threshold torque for the variable speed drive:
determine whether a length of time that the rotational speed of the rotor shaft is set to the second rotational speed exceeds a threshold length of time for the second rotational speed;
measure the vacuum pressure of the at least one filter element;
determine whether the vacuum pressure of the at least one filter element is greater than a high threshold vacuum pressure of the at least one filter element; and
when (i) the length of time that the rotational speed of the rotor shaft is set to the second rotational speed exceeds the threshold length of time for the second rotational speed and (ii) the vacuum pressure of the at least one filter element is greater than the high threshold vacuum pressure of the at least one filter element, shut down the disc filter system.

8. The disc filter system of claim 1, wherein the second rotational speed is less than the first rotational speed.

9. The disc filter system of claim 1, wherein the control system is further communicatively coupled to a pressure sensor fluidly coupled to the at least one filter element and operable to measure a vacuum pressure of the at least one filter element, and wherein the machine readable and executable instructions, when executed by the processor, further cause the disc filter system to automatically:
determine whether the torque on the variable speed drive is less than a low threshold torque for the variable speed drive;
measure the vacuum pressure of the at least one filter element;
determine whether the vacuum pressure of the at least one filter element is greater than a high threshold vacuum pressure of the at least one filter element; and
when (i) the torque on the variable speed drive is less than the low threshold torque for the variable speed drive and (ii) the vacuum pressure of the at least one filter element is greater than the high threshold vacuum pressure of the at least one filter element, decrease the rotational speed of the rotor shaft, via the variable speed drive, from the first rotational speed to the second rotational speed, wherein the second rotational speed is less than the first rotational speed.

10. A method for dewatering fiber suspension, the method comprising:
introducing a fiber suspension to a disc filter comprising:
a vessel comprising an inlet positioned in a wall of the vessel, the inlet being configured to introduce a fiber suspension into the vessel;
a rotor shaft comprising a shaft axis of rotation; and
at least one filter element coupled to the rotor shaft wherein the at least one filter element rotates with the rotor shaft about the shaft axis of rotation;
rotating the rotor shaft about the shaft axis of rotation;
measuring a torque on a drive used to rotate the rotor shaft about the shaft axis of rotation; and
adjusting a rotational speed of the rotor shaft from a first rotational speed to a second rotational speed that is non-zero and different from the first rotational speed based on the torque on the variable speed drive.

11. The method of claim 10, wherein the second rotational speed is greater than the first rotational speed.

12. The method of claim 10, further comprising:
determining whether the torque on the variable speed drive is greater than a high threshold torque for the variable speed drive; and
increasing the rotational speed of the rotor shaft from the first rotational speed to the second rotational speed when the torque on the variable speed drive is greater than the high threshold torque for the variable speed drive, wherein the second rotational speed is greater than the first rotational speed.

13. The method of claim 12, further comprising:
measuring a fill level of the fiber suspension in the vessel;
determining whether the fill level of the fiber suspension in the vessel is less than a threshold fill level of the fiber suspension in the vessel; and
diluting the fiber suspension when the fill level of the fiber suspension in the vessel is less than the threshold fill level of the fiber suspension in the vessel.

14. The method of claim 13, wherein the inlet is connected to a conduit through which the fiber suspension is supplied to the inlet, and wherein diluting the fiber suspension comprises increasing a flow rate of dilution liquid to the conduit.

15. The method of claim 10, wherein the disc filter further comprises at least one injector positioned in the wall of the vessel, the at least one injector being configured to introduce a secondary flow of fiber suspension into the vessel, and wherein the method further comprises:
measuring a fill level of the fiber suspension in the vessel;
determining whether the fill level of the fiber suspension in the vessel is less than a threshold fill level of the fiber suspension in the vessel; and
when the fill level of the fiber suspension in the vessel is less than the threshold fill level of the fiber suspension in the vessel, increasing a flow rate of the fiber suspension into the vessel by increasing a flow rate of the fiber suspension introduced into the vessel via the inlet, increasing a flow rate of the secondary flow of fiber suspension introduced into the vessel via the at least one injector, or both.

16. The method of claim 12, wherein the method further comprises, when the torque on the variable speed drive is greater than the high threshold torque for the variable speed drive:
determining whether a length of time that the rotational speed of the rotor shaft is set to the second rotational speed exceeds a threshold length of time for the second rotational speed;
measuring a vacuum pressure of the at least one filter element;
determining whether the vacuum pressure of the at least one filter element is greater than a high threshold vacuum pressure of the at least one filter element; and
shutting down the disc filter when (i) the length of time that the rotational speed of the rotor shaft is set to the second rotational speed exceeds the threshold length of time for the second rotational speed and (ii) the vacuum pressure of the at least one filter element is greater than the high threshold vacuum pressure of the at least one filter element.

17. The method of claim 10, wherein the second rotational speed is less than the first rotational speed.

18. The method of claim 10, wherein the method further comprises, when the torque on the variable speed drive is less than a low threshold torque for the variable speed drive:
measuring a vacuum pressure of the at least one filter element;
determining whether the vacuum pressure of the at least one filter element is greater than a high threshold vacuum pressure of the at least one filter element; and
decreasing the rotational speed of the rotor shaft from the first rotational speed to the second rotational speed when (i) the torque on the variable speed drive is less than the low threshold torque for the variable speed drive and (ii) the vacuum pressure of the at least one filter element is greater than the high threshold vacuum pressure of the at least one filter element, wherein the second rotational speed is less than the first rotational speed.

19. The method of claim 10, wherein the drive is a variable speed drive.
